(19) United States
(12) Patent Application Publication
(10) Pub. No.: US 2008/0264119 A1
(43) Pub. Date: Oct. 30, 2008

(54) LOCK

(76) Inventor: Jerome Thomas, Tregaron (GB)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 11/751,052

(22) Filed: May 21, 2007

(30) Foreign Application Priority Data
Apr. 26, 2007 (GB) 0708088.0

(51) Int. Cl. E05B 65/00

(52) U.S. Cl. 70/77

(57) ABSTRACT

A lock 10 comprises a planar member 12 for attaching to a side of a frame, for example, a door frame 20 and a locking element 14 including a locking face 28 rotatably mounted to the planar member 12 about a pivot 16. The axis of the pivot 16 lies substantially parallel to the plane of the planar member 12, and the locking element 14 is movable, in use, between an unlocked position, wherein the locking element 14 lies entirely to one side of the planar member 12, and a locked position, wherein the locking element 14 lies at least partially to the other side of the planar member 12 and the locking face 28 is substantially perpendicular to the substantially planar member 12, thereby blocking movement of a wing, for example, a door 26 mounted in the frame 20.

### BACKGROUND OF THE INVENTION

The present invention relates to a lock and particularly, but not exclusively, to a lock for a wing such as a door or a window.

### SUMMARY OF THE INVENTION

According to the present invention there is provided a lock comprising a substantially planar member for attaching to a frame and a locking element including a locking face rotatably mounted to the substantially planar member about a pivot, the axis of the pivot lying substantially parallel to the plane of the substantially planar member, and the locking element being movable, in use, between an unlocked position in which the locking element lies entirely to one side of the planar member and a locked position in which the locking element lies at least partially to the other side of the planar member and the locking face is substantially perpendicular to the substantially planar member.

The pivot may lie to said one side of the substantially planar member and at one distal end thereof.

A flange may be disposed at the other distal end of the substantially planar member.

The flange may be either curved or pointed. In one embodiment, the flange may comprise a pair of pointed flanges extending side by side from the substantially planar member.

When fitting the substantially planar member to a frame, for example a door frame, the flanges can simply be pressed, either by hand or with an implement such as a hammer, into the side of the frame. This obviates the need for fastening with fixings, for example screw fixings, although fixings can be utilised for added strength and for long term use.

An advantage of using the flange without fixings is that the lock may simply be removed with minimal damage to the frame to which it is attached.

The substantially planar member may be made from flat material.

Alternatively the substantially planar member may be formed from strip material formed in a U-shape.

The material may be metal or plastics.

The flange may be integral with the substantially planar member.

The locking element may be resilient and clip onto the pivot.

The locking element may have a dog-leg or off-set portion along its length. Alternatively, the locking element may be formed as a pair of spaced planar wedge shaped members, joined by at least one web. These arrangements are advantageous because they transmit force from a wing being locked, through their locking faces, substantially directly back to the pivot point. Thus the locking element is in compression in this condition and the substantially planar member is in tension.

Fixing apertures may be provided through the substantially planar member. The apertures may be countersunk, for minimal invasion into the space between a frame and an opening wing or member.

A latching sprue or other latch means may be disposed on the locking element which is adapted to engage with the substantially planar member. Alternatively a latching sprue or other latch means may be disposed on the substantially planar member, which is adapted to engage with the locking element.

An advantage of the latching sprue is that the locking element is held in the locking position, once set, and will not tend to move accidentally to the open position.

At least one tab may be disposed on the locking element for facilitating the movement of the locking element relative to the substantially planar member by hand.

The tab may extend away from the locking element, enabling the tab to be pushed or manipulated by hand for easy movement of the locking element by hand.

In one arrangement, the locking face may be spaced from the distal end of the locking element. This allows a wing, for example a door, to be partially opened before engaging the lock in the locked position.

The lock may comprise any suitable number of locking elements mounted on the planar member. They may be linked together to move as one.

The or each locking element may be motorised, and may be controlled remotely, for example, by aerial remote control.

A pad may be disposed on the locking face, which may include a sensor.

The pivot may extend perpendicularly or parallel to a central axis of the substantially planar member.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a schematic view of a first embodiment of lock attached to a doorframe, with the lock in an unlocked position;

FIG. 2 shows the lock of FIG. 1 in a locked position;

FIG. 3A shows a schematic view of an alternative embodiment of a substantially planar member of the lock;

FIG. 3B shows a schematic view of a second alternative embodiment of the substantially planar member of the lock;

FIG. 3C shows a schematic view of a third alternative embodiment of the substantially planar member of the lock;

FIG. 3D shows a schematic view of a fourth alternative embodiment of the substantially planar member of the lock;

FIG. 4A shows a schematic view of a first alternative embodiment of a locking element of the lock;

FIG. 4B shows a schematic view of a second alternative embodiment of the locking element of the lock;

FIG. 4C shows a schematic view of a third alternative embodiment of the locking element of the lock;

FIG. 5 shows a schematic view of a plurality of alternative embodiments of the locking element of the lock;

FIG. 6 shows a schematic view of a pressed metal embodiment of the lock in the locked and unlocked positions;

FIG. 7A shows a schematic view of an alternative embodiment of lock having two locking elements;

FIG. 7B shows a schematic view of an alternative embodiment of lock having four locking elements;

FIG. 8 shows a schematic view of an alternative embodiment of lock having a stepped locking face, with the lock in an unlocked position;

FIG. 9 shows the lock of FIG. 8 with the lock in a locked position;

FIG. 10 shows a schematic view of an alternative embodiment of lock adapted for remote operation, with the lock in an unlocked position;

FIG. 11 shows the lock of FIG. 10 with the lock in a locked position;

FIG. 12 shows a schematic view of an embodiment of lock including a spring for biasing the lock to the locked position;

FIG. 13 shows a schematic view of an embodiment of lock including a latch for maintaining the lock in the locked position;

FIG. 14 shows a schematic view of an embodiment of lock including a sprue for maintaining the lock in the locked position;

FIG. 15 shows a schematic view of an alternative embodiment of lock including a latch for maintaining the lock in the locked position;

FIG. 16 shows a schematic view of an example of a sprue and various latching arrangements;

FIG. 17 shows a schematic view of an alternative embodiment of lock including a contact for triggering an alarm, with the lock in an unlocked position;

FIG. 18 shows the lock of FIG. 17 with the lock in a locked position;

FIG. 19 shows a schematic view of an alternative embodiment of the lock of FIGS. 17 and 18 including a strengthening brace, with the lock in an unlocked position;

FIG. 20 shows a schematic cross-sectional view of an alternative embodiment of lock fitted to a door frame, with the lock in a locked position;

FIG. 21 shows a schematic perspective view of the lock of FIG. 20;

FIG. 22 shows a schematic front view of an alternative embodiment of lock fitted to a door frame, with the lock in a locked position;

FIG. 23 shows a schematic perspective view of the lock of FIG. 22;

FIG. 24 shows a schematic view of an alternative embodiment of lock, with the lock in an unlocked position;

FIG. 25 shows the lock of FIG. 24 with the lock in a locked position;

FIG. 26 shows a schematic view of an alternative embodiment of lock, with the lock in an unlocked position; and

FIG. 27 shows the lock of FIG. 24 with the lock in a locked position.

### DETAILED DESCRIPTION OF THE ILLUSTRATIVE EMBODIMENTS

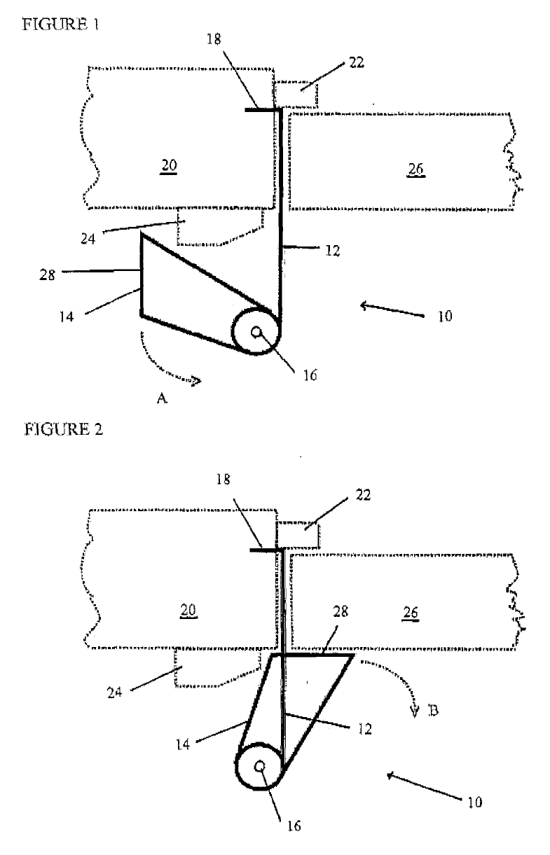

Referring firstly to FIGS. 1 and 2, a lock is indicated generally at 10. The lock 10 includes a planar member 12 and a locking element 14 rotatably mounted to the planar member 12 about a pivot 16. The pivot 16 is disposed at the distal end of the planar member 12. A flange or tang 18 extends perpendicularly from the other distal end of the planar member 12 and is shown engaged with a doorframe 20, indicated in dotted outline. The doorframe includes a doorstop 22 and architrave 24, and a door 26, also indicated in dotted outline, is shown in a closed position within the doorframe 20.

The pivot 16 is offset to one side of the planar member 12, so that the pivot 16 does not impede movement of the door 26 between the closed and open positions. As shown in FIG. 1, the locking element 14 is disposed entirely to one side of the planar member 12, that is, to the left hand side as viewed. In this position, the lock is unlocked and the door 26 is free to move to the open position from the closed position. In order to lock the door, the locking element 14 is moved by hand or foot to the position shown in FIG. 2, as indicated by arrow A.

The locking element 14 has a locking face 28, which in the locked position abuts against the face of the door 26 and retains it in the closed position. When the door is pushed from the other side, this causes compression of the locking element 14 onto the pivot 16 and the planar member 12 is put in tension. The locking face 28 of the locking element 14 acts against the face of the door 26 and blocks movement of the door to the open position. In order to achieve this effect, a proportion of the locking element 14 lies to the other side of the planar member 12, that is, to the right hand side, as viewed.

Friction is sufficient to hold the locking element in the locked position, but a latching sprue or nib may be disposed on the locking element, which is adapted to engage with the substantially planar member to prevent the locking member slipping to the open position. In order to move the locking element 14 to the open position, it is moved as indicated by the arrow B in FIG. 2, to the open position, shown in FIG. 1.

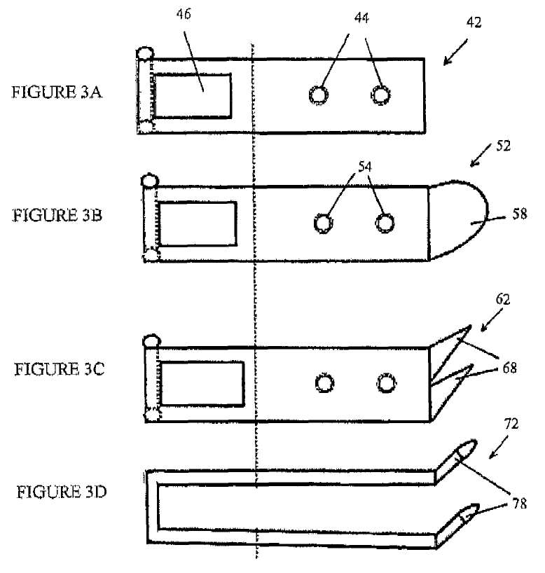

FIGS. 3A to 3D show alternative embodiments of the planar member 12, indicated at 42, 52, 62 and 72. The planar member 42 does not include the flange 18 of the first embodiment, but instead has countersunk apertures 44 for fastening with screw fixings (not shown). A cut out 46 is also provided in the planar member 42.

The planar member 52 is similar to the planar member 42, save that it has a curved flange 58 for fixing as well countersunk apertures 54.

The planar member 62 is similar to the planar member 52, save that the curved flange 58 has been replaced by a pair of pointed flanges 68 lying side by side. This facilitates pushing the flanges 68 into a frame by hand. In other embodiments, not shown, there may be three or more pointed or curved flanges.

The planar member 72 is constructed as a U-shaped, either from a strip material, or from moulded plastics. The strip material may have a flat, circular or any suitable cross section. Again, two pointed flanges 78 are provided for ease of attachment.

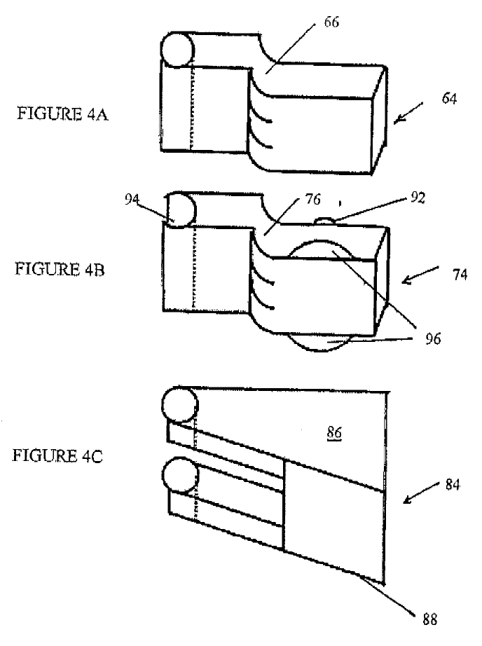

FIGS. 4A to 4C show alternative embodiments of the locking element 12, indicated at 64, 74 and 84. The locking element 64 is formed with a dog-leg 66. The locking element 74 is formed with a similar dog-leg, but is also formed with a latching sprue 92, a clip on hinge portion 94, and user tabs 96 top and bottom to facilitate operation.

The locking element 84 is formed as a pair of pair of adjoined spaced wedge shaped or substantially triangular members 86, 88.

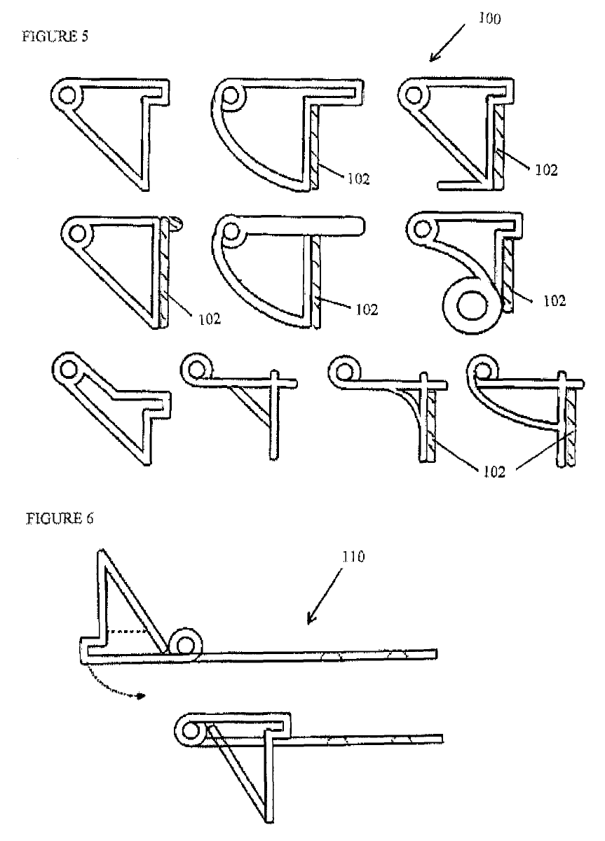

Referring now to FIG. 5, a plurality of different designs of locking element are shown, indicated generally at 100. Some of the locking elements 100 are shown with pads 102, mounted on the surface of the locking faces of the locking elements. The pads 102 may be made from rubber, or other suitable material, and may have an outwardly textured surface in order to increase the friction between a wing and locking element. These designs 100 are intended for manufacture by extrusion of plastics, metals or composites.

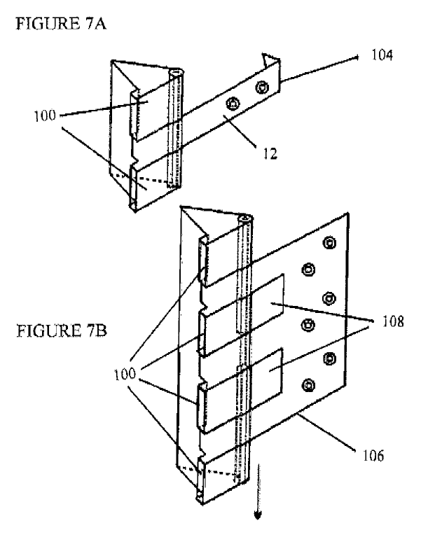

The lock may be made in any desired length, and an example of a lock having two locking elements is shown in FIG. 7A at 104. This lock 104 includes two locking elements 100 mounted one above the planar member 12 and the other below the planar member 12, in the manner of a conventional butt hinge. The locking elements 100 may be linked. In FIG. 7B, a lock 106 includes a planar member having two cut-outs 108 to allow through movement of locking elements 100. In this arrangement there are four locking elements 100, which are preferably linked together, so that they all move between the locked and unlocked positions together. It is intended that the invention should include locks having any number of locking elements, or any length of locking element, because increasing the length and/or number increases the strength and effectiveness of the lock.

FIG. 6 shows an example of a lock 110 in the open and closed positions, in which the planar member and locking element are made from pressed or folded sheet metal. The principle of the lock 110 is identical to that of lock 10 shown in FIGS. 1 and 2.

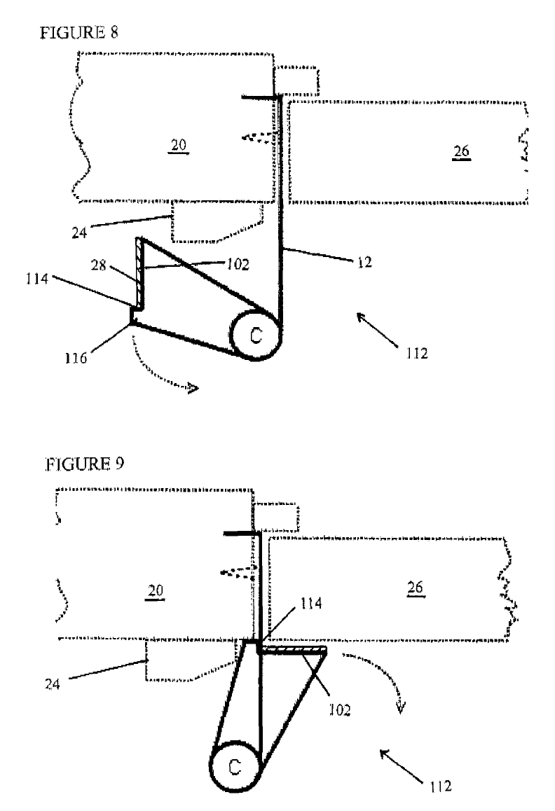

A lock 112 is indicated in FIGS. 8 and 9, in respective unlocked and locked positions. This lock 112 is substantially identical to the lock 10, and the same reference numerals have been used to denote parts in common. One difference is that the lock 112 has a shoulder 114 formed by a projection 116 at one end of the locking face 28, to the left hand side of the locking face 28, as viewed. This shoulder 114 serves to prevent the locking element 14 rotating to the unlocked position if the door 26 is engaged with the locking face 28. A pad 102 is also disposed on the locking face.

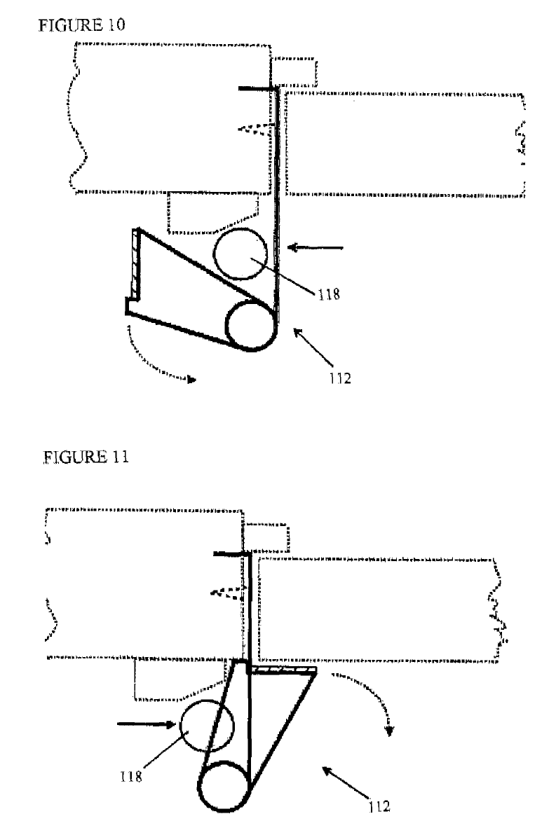

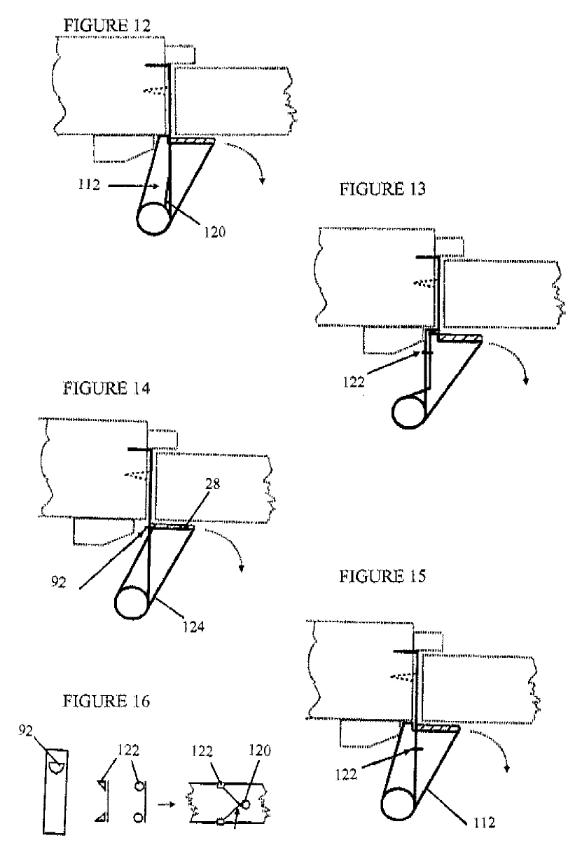

Referring to FIGS. 10 and 11, the lock 112 of FIGS. 8 and 9 is shown in the open and closed positions respectively, but the movement is powered by a motor or solenoid 118, indicated schematically. The motor or solenoid 118 can be directly switch operated or by aerial remote control, for example, for use by the physically disabled. Referring to FIG. 12, the lock 112 is shown fitted with a spring 120, which returns the lock to locked position. Referring to FIG. 15, the lock 112 is shown with a latch 122, shown schematically, for retaining the locking element in the locked position. The latch 122 is also shown in FIG. 13, in use with a different shape of locking element. In this embodiment, the planar member is provided with a dog-leg for added strength and also to accommodate the geometry of certain door frames and the like.

Referring to FIG. 14, a lock 124 is shown with a further alternative shape of locking element, which incorporates the latching sprue 92 extending from the end of the locking face 28. As in the embodiment shown in FIG. 4B, the sprue holds the locking element in the locked position.

FIG. 16 shows part of a locking element or planar member with an example of the sprue 92. The sprue protrudes from the surface of the locking element or planar member and engages in a correspondingly shaped aperture in the other of the locking element or planar member. Examples of latches are shown at 122 in cross section, and a latch 122 and spring 120 are shown to the right hand side of FIG. 16. In some arrangements, the latch may be released by aerial remote control.

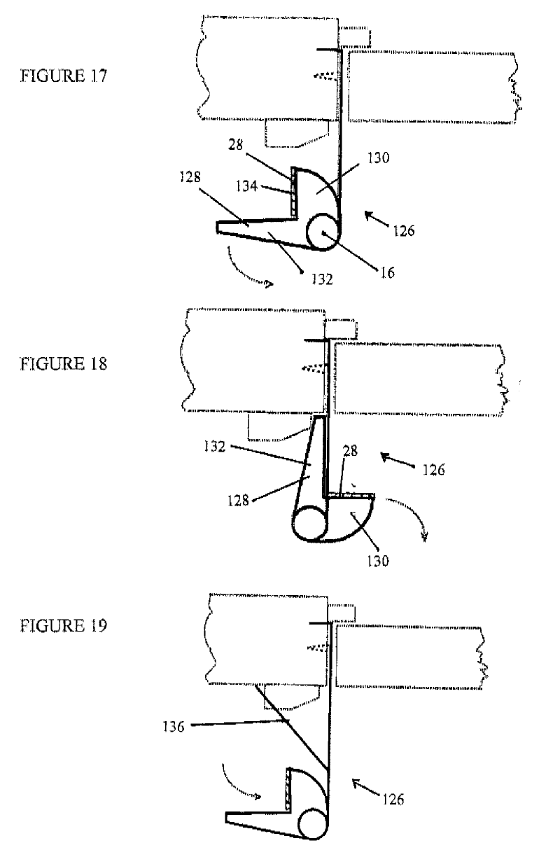

Referring to FIGS. 17 and 18, an embodiment of lock 126 is shown in the open and closed positions respectively. In this embodiment, the locking element 128 is shaped substantially as an “L” shape, with the pivot 16 substantially at the corner of the “L” shape. In other words, the locking element 128 comprises two portions 130,132 substantially at right angles to one another and meeting at a corner, substantially at the position of the pivot 16. The axis of the pivot does not lie at the position where the surfaces of the portions 130,132 intersect, but is spaced therefrom. The locking face 28 is disposed on a surface of the portion 130, which lies immediately adjacent the portion 132. Therefore, in the locked position, as shown in FIG. 18, the locking surface 28 is spaced from the door 26. A pad 134 is attached to the locking surface, which either functions as the pads previously described, or houses a contact or sensor for triggering an alarm.

In use, when the door 26 is opened, it is able to move a short distance, comparable to the movement allowable by a typical door safety chain, say approximately 2 inches. If the sensor or contact is included in the pad 134, then an alarm, for example a visible and/or audible alarm may be triggered.

FIG. 19 shows an embodiment of the lock 126, shown in FIGS. 17 and 18, in which the planar member is strengthened by a diagonal brace 136. The brace 136 can be attached to the door or other frame, if desired.

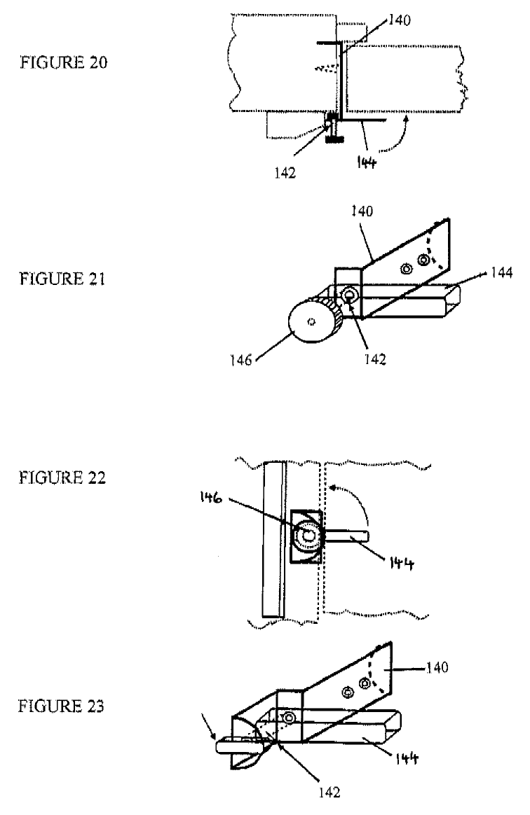

FIGS. 20 to 23 show various alternative embodiments of a lock comprising a planar member 140, for attachment to the door frame 20 as previously described, and pivot 142 mounted substantially parallel to the axis of the planar member 140 and set to one side thereof. A locking element 144 is mounted about the pivot 142 and is movable by means of a knob or lever 146 between an open position, in which the locking element lies entirely to one side of the planar member 140, ie allowing free movement of the door 26 and a locked position, in which the locking element lies partially over the face of the door 26. In other words, the lock is similar to those previously described, save that the axis of the pivot is rotated through 90 degrees.

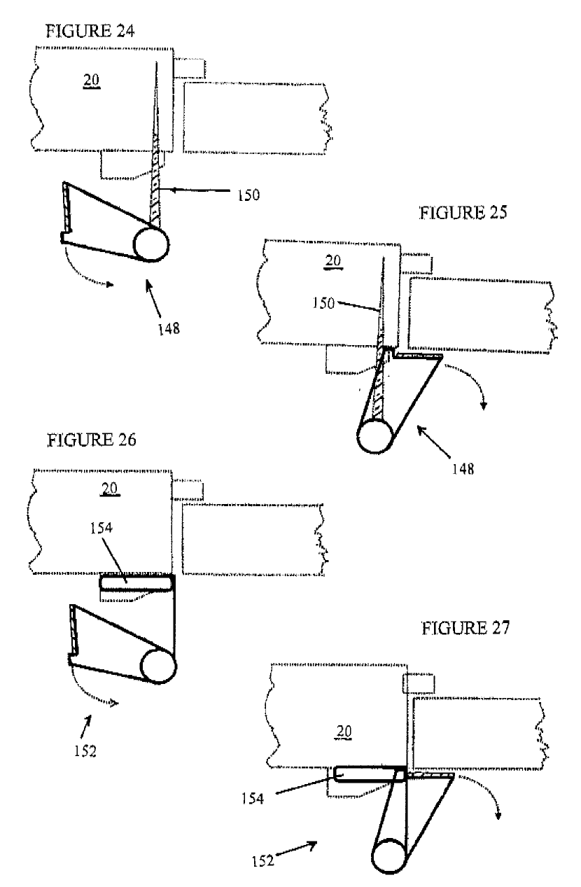

Referring to FIGS. 24 and 25, a lock 148 is shown in which the planar member is substantially a spike, screw or auger 150 for direct attachment top the door frame 20.

Referring to FIGS. 26 and 27, a lock 152 is shown in which the planar member is terminated at a perpendicular flange 154, which attaches to the face of the door frame 20.

The features of the various embodiments of planar members are intended to be interchangeable. Similarly, the features of the various embodiments of locking elements are intended to be interchangeable.

In all embodiments, the parts of the planar members can be made either integrally or separately and connected together, either from metals or plastics. Similarly, the parts of the locking elements can be made either integrally or separately and connected together, either from metals or plastics.

Use of the lock is not intended to be limited to doors. The lock can be used with drawers and windows, and in any suitable application where one part moves relative to another.

It is understood that variations may be made in the foregoing without departing from the scope of the invention. For example, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the invention may be employed without a corresponding use of the other features. Accordingly, it is appropriate that the appended claims be construed broadly and in a manner consistent with the scope of the invention.

1. A lock comprising a substantially planar member for attaching to a frame and a locking element including a locking face rotatably mounted to the substantially planar member about a pivot, the axis of the pivot lying substantially parallel to the plane of the substantially planar member, and the locking element being movable, in use, between an unlocked position in which the locking element lies entirely to one side of the planar member and a locked position in which the locking element lies at least partially to the other side of the planar member and the locking face is substantially perpendicular to the substantially planar member.

2. A lock as claimed in claim 1, wherein the pivot lies to said one side of the substantially planar member.

3. A lock as claimed in claim 1, wherein the pivot is disposed at one distal end of the substantially planar member.

4. (canceled)

5. (canceled)

6. (canceled)

7. (canceled)

8. A lock as claimed in claim 1, wherein the substantially planar member is formed as a screw fixing.

9. (canceled)

10. A lock as claimed in claim 1, wherein the locking element is resilient and clips onto the pivot.

11. A lock as claimed in claim 1, wherein the locking element has a dog-leg or off-set portion along its length.

12. A lock as claimed in claim 1, wherein the locking element is formed from a pair of spaced planar members, joined by at least one web member.

13. A lock as claimed in claim 1, wherein fixing apertures are provided through the substantially planar member.

14. A lock as claimed in claim 1, wherein a latch means is disposed on the locking element, which is adapted to engage with the substantially planar member.

15. A lock as claimed in claim 1, wherein a latch means is disposed on the substantially planar member, which is adapted to engage with the locking element.

16. A lock as claimed in claim 1, wherein at least one tab is disposed on the locking element for facilitating the movement of the locking element relative to the substantially planar member by hand.

17. A lock as claimed in claim 1, wherein the locking face is spaced from a distal end of the locking element.

18. A lock as claimed in claim 1, wherein a plurality of locking elements are rotatably mounted to the substantially planar member.

19. A lock as claimed in claim 19, wherein the locking elements are linked and rotate as one.

20. A lock as claimed in claim 1, wherein the movement of the locking element is motorised.

21. A lock as claimed in claim 20, wherein the movement of the locking element is controlled by aerial remote control.

22. A lock as claimed in claim 1, wherein a pad is disposed on the locking face.

23. A lock as claimed in claim 22, wherein the pad includes a sensor.

24. A lock as claimed in claim 1, wherein the pivot extends substantially perpendicularly to a central axis of the substantially planar member.

25. A lock as claimed in claim 1, wherein the pivot extends substantially parallel to a central axis of the substantially planar member.
